(19) United States
(12) Patent Application Publication
(10) Pub. No.: US 2021/0132826 A1
(43) Pub. Date: May 6, 2021

(54) SECURING A COLLECTION OF DEVICES USING A DISTRIBUTED LEDGER

(71) Applicant: Seagate Technology LLC, Cupertino, CA (US)

(72) Inventors: Kwong Heng Alphonsus John Kwok, Singapore (SG); Kian Beng Lim, Singapore (SG); Wei Siong Teo, Singapore (SG); Vincent Uy, Singapore (SG); Nino Wicaksono, Singapore (SG)

(21) Appl. No.: 16/676,068

(22) Filed: Nov. 6, 2019

(51) Int. Cl. G06F 3/06; H04L 9/06; H04L 9/32

(52) U.S. Cl. CPC G06F 3/0622; G06F 3/0637; H04L 9/3213; H04L 9/0637; G06F 3/067

(57) ABSTRACT

Apparatus and method for local authentication of a collection of processing devices, such as but not limited to storage devices (e.g., SSDs, etc.). In some embodiments, each of the processing devices stores an internal token value as a unique ID value associated with the corresponding processing device. A host controller circuit performs a local authentication of the collection by accessing a distributed ledger as a data structure in a memory that lists the internal token values of the respective processing devices. The distributed ledger may take the form of a blockchain. The processing devices may each further store an external token value as the internal token value of a selected one of the other processing devices in the collection. A newly added device may be initially authenticated using a remote server. Once authenticated, the device is added to the collection and thereafter authenticated locally.

### SUMMARY

Various embodiments of the present disclosure are generally directed to device authentication systems, and more particularly to the local authentication of a collection of devices, such as but not limited to data storage devices coupled to an edge computing device.

In some embodiments, each of the processing devices stores an internal token value as a unique ID value associated with the corresponding processing device. A host controller circuit performs a local authentication of the collection by accessing a distributed ledger as a data structure in a memory that lists the internal token values of the respective processing devices.

These and other features which characterize various embodiments of the present disclosure can be understood in view of the following detailed discussion and the accompanying drawings.

### BRIEF DESCRIPTION OF THE DRAWINGS

FIG. 1 is a functional block representation of a data processing system which operates in accordance with various embodiments of the present disclosure.

FIG. 2 shows a configuration of a computer network that may employ data processing elements of FIG. 1 in some embodiments.

FIG. 3 is a sequence diagram illustrating an authentication transaction carried out using a remote trusted server in some embodiments.

FIG. 4 is a functional block diagram of a trust group having a host and a collection of processing devices in accordance with some embodiments.

FIG. 5 shows a key store for each of the devices in the trust group of FIG. 4.

FIG. 6 is a format for a ledger block of a distributed ledger used by the host in FIG. 4 during a local authentication process.

FIG. 7 shows a format for the distributed ledger in some embodiments.

FIG. 8 shows operation of the host from FIG. 4 to update the distributed ledger.

FIG. 9 is a diagram of a system authentication sequence carried out by the group of FIG. 4 in some embodiments.

FIG. 10 shows a missing member resolution sequence.

FIG. 11 shows a new device detection sequence.

FIGS. 12A and 12B show external token associations that can be carried out in some embodiments.

FIG. 13 shows a multi-device storage system in accordance with further embodiments.

FIG. 14 shows a storage enclosure from FIG. 13 in some embodiments.

### DETAILED DESCRIPTION

Data security schemes are used to reduce or eliminate unauthorized access to data processing systems. Data security schemes can employ a variety of cryptographic security techniques to protect such systems from third party attacks.

Some systems use a centralized trust-based security protocol to allow a particular host device to gain access to a peripheral device, such as a data storage device. The protocol may involve various steps carried out to respectively authenticate the host, to authenticate the storage device to a remote centralized server (such as a trusted security infrastructure or TSI server), and to authenticate the server to the host and the storage device. Authentication can be carried out in a variety of ways such as through the use of encrypted challenge values, public and private encryption keys, hashes, digital signatures, biometric inputs, etc. Once the various entities have been mutually verified to each other, a secure operation can be carried out between the host and the peripheral device such as an access to a secured data storage volume, a change in device configuration, etc.

Centralized trust-based security protocols can require significant system resources at both the local device level and the remote server level to track and authenticate the various entities and the requested transactions. This can be time and bandwidth intensive, particularly in applications such as private cloud environments or edge computing environments where a collection of local devices provide distributed storage and processing capabilities. Centralized security protocols are not always feasible in geographically remote locations where intermittent or non-existent communications can be maintained with remote security server resources.

Various embodiments of the present disclosure are generally directed to an apparatus and method for system authentication in a data processing environment. As explained below, some embodiments provide a collection of local devices, such as data storage devices. The local devices are coupled to a host device, such as an edge computing device that provides edge of cloud processing and transactions with remote cloud servers and other cloud elements.

A data structure referred to as a distributed ledger is generated and maintained by the host device to describe the various local devices (also referred to as “collection members”). The distributed ledger may take the form of a blockchain or some other suitable form. The distributed ledger is used to authenticate each of the collection members without the need for a separate authentication operation across the network. Newly added devices are registered with the collection and added to the distributed ledger. The ledger or portions thereof may be shared among the local devices to enable secure communications therebetween. Rogue devices will be inhibited from joining or participating in the collection without first being added to the ledger.

In some cases, an identifying token may be formed to uniquely describe each authorized collection member to the host device. In one example, tokens are formed by applying a selected hash function to certain unique identification (ID) information associated with each local device, such as serial numbers or other types of information. Each local device may further store token information associated with another local device in the collection. The token information is incorporated into the ledger and used during group authentication.

It is contemplated that all of the collection members will reside in a single geographical location such as in one or more storage enclosures, racks, a data center, a local IoT environment, etc. This is not necessarily required, however, as the various collection members can be geographically distributed as desired. Reference to “local” authentication means authentication without the need for the host to consult a centralized server or other authority to complete the authentication.

A multi-level authentication process can be implemented. Individual groups of devices can form sub-collections that are separately authenticated as described above. The sub-collections can, in turn, be members of a larger collection that is similarly authenticated.

The system provides fast and efficient authentication. If the system verifies correctly, there is high trust that the system is authenticated and secure without the need to obtain certificates or other authentication information from a remote authority. The detection of both missing members and new members can be handled appropriately.

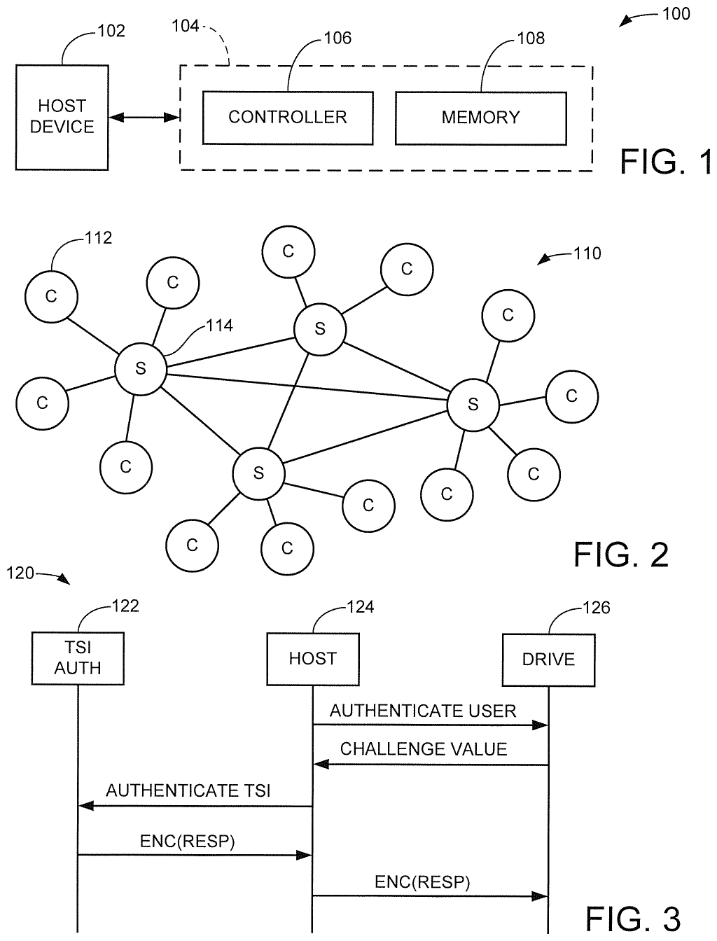

These and other features and advantages of various embodiments can be understood beginning with a review of FIG. 1 which shows a data processing system 100. The data processing system 100 includes a host device 102 operably coupled to a data storage device 104. This is merely exemplary as any number of different types of data processing environments can be used as desired, including environments that do not involve data storage systems.

The host device 102 and the data storage device 104 in FIG. 1 can each take a variety of forms. Without limitation, the host device 102 may take the form of a personal computer, workstation, server, laptop, portable handheld device, smart phone, tablet, gaming console, RAID controller, cloud controller, storage enclosure controller, etc.

The data storage device 104 may be a hard disc drive (HDD), solid-state drive (SSD), hybrid solid state drive (HSSD), thumb drive, optical drive, an integrated memory module, a multi-device storage enclosure, or some other form of device.

The data storage device 104 may be incorporated into the host device as an internal component or may be an external component accessible via a communication pathway with the host device 102 including a cabling connection, a wireless connection, a network connection, etc.

For purposes of the present discussion, it will be contemplated that the host device 102 is a computer and the data storage device 104 provides a main memory store for user data generated by the host device, such as flash memory in a solid state drive (SSD).

FIG. 2 shows a distributed computer network 110. The network 110 has a number of interconnected processing nodes including client (C) nodes 112 and server (S) nodes 114. The client nodes may represent local user systems with host computers 102 and one or more storage devices 104 as depicted in FIG. 1. The server nodes may interconnect groups of remotely connected clients. Other arrangements can be used. It will be understood that the authentication processing described herein can be carried out by both server and client nodes.

Generally, any node in the system can communicate directly or indirectly with any other node. The network 110 can be a private network, a public network, or a combination of both public and private networks. Local collections of devices can be coupled to edge computing devices that provide edge of Internet processing for larger cloud-based networks. It is contemplated that the overall network 110 is a low trust environment potentially susceptible to attacks by third parties. Authentication security schemes are implemented to protect against such attacks, as will now be described.

FIG. 3 is a sequence diagram 120 illustrating a remote authentication sequence that may be carried out by aspects of the network 110 in accordance with some embodiments. A trusted security infrastructure (TSI) 122, also sometimes referred to as the TSI authority or the TSI authority circuit, is a logical entity comprised of hardware and/or software designated to handle certain functions within the protection scheme. The TSI authority 122 may be a separate server dedicated to this purpose, or may be managed and distributed as required among various nodes by authorized system administrators (administrative users). The TSI authority 122 may form a portion of a remote security (key) management system in which system authentication techniques, including the transfer of encryption keys, certificates or other authentication data are passed to provide access to the system. The TSI authority communicates to a device using a selected security protocol.

A host 124 and a drive 126 (e.g., an SSD) are arranged to communicate with the TSI authority 122. In this example, the host 124 initiates a sequence to gain authorized access a protected security aspect of the drive 126. In order to do so, sufficient trust must be established between the TSI authority 122, the host 124 and the drive 126. To authenticate each of these entities to the others, the host 124 may initiate the process such as by requesting an encrypted challenge string from the drive 126. The host may supply an initial value which is encrypted by the drive, or some other sequence may be employed. The challenge value may be forwarded to the TSI Authority 122, which processes the challenge value in some way to provide an encrypted response, which may be processed by the host and the drive.

Once all entities are satisfied, the host proceeds with the requested transaction. Examples that may involve requested transactions may include normal data accesses including accesses to secured volumes, etc. Diagnostic functions may also be enacted such as installing new firmware, performing specific security actions such as secure erasure, drive unlock, enablement of serial ports, etc. Many such inter-entity sequences are known in the art, and substantially any suitable sequence can be used as desired.

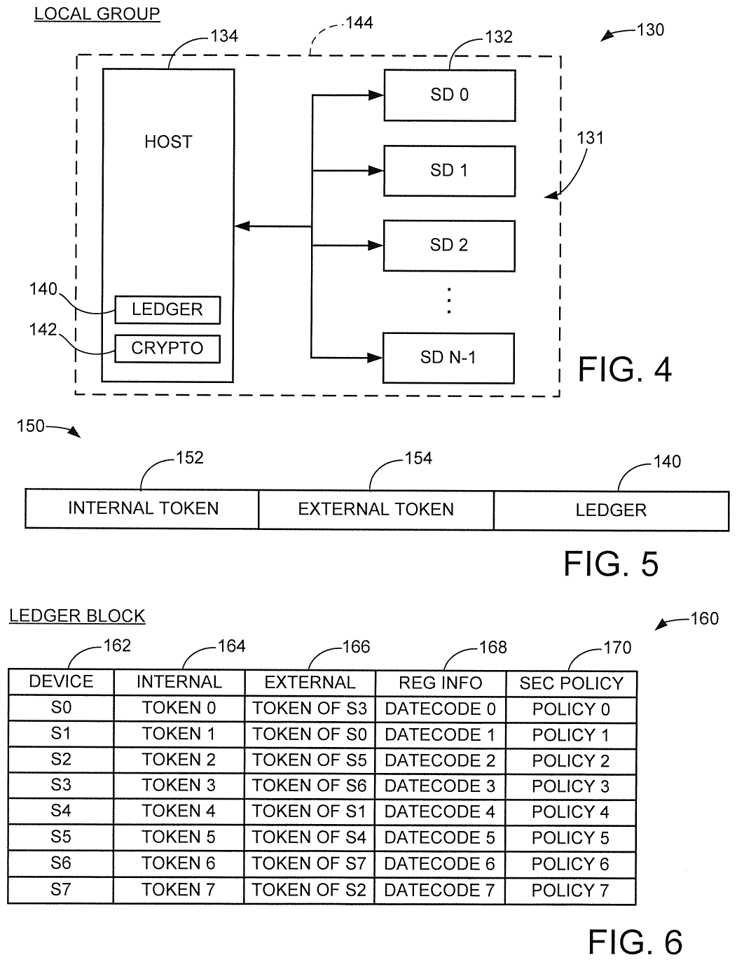

While operable, the centralized system 120 of FIG. 3 is not always suitable for certain types of authentication processing. One such example is provided in FIG. 4 which shows a local processing group 130 constructed in accordance with some embodiments. The group 130 is exemplified as a local storage node of the network 110 of FIG. 2, but other types of groups can be used such as, but not limited to, a collection of IoT (Internet of Things) devices that cooperate to provide data generation, processing and/or storage in a particular location. In some embodiments, the group 130 is physically disposed within an enclosure, rack or other arrangement to provide local mass storage for an end user, such as in a private cloud environment.

The group 130 includes a collection 131 of individual, local storage devices 132 coupled to a host 134. The storage devices are shown to be SSDs, but other forms of devices can be used. The host 134 comprises an edge server or other processing device.

The number N of storage devices 132 (“collection members”) can vary widely depending on the requirements of a given application, from values as low as 2-3 to values of several hundred or more. A suitable range for many applications may be around 5-20 devices, although families of up to about 200-300 or so may be useful for some environments. Groups of the devices 132 may be arranged into sub-collections to expedite authentication processing. The devices may be arranged in one or more storage enclosures.

For local groups such as 130, it may not be suitable or feasible to undergo remote authentication of each of the storage devices 132 in the collection 131 the manner set forth by FIG. 3. At the same time, failure to perform some sort of localized authentication at the device level could potentially provide an attacker with an opportunity to breach the system using a direct or side-channel attack.

Accordingly, the group 130 uses a distributed ledger 140 to perform localized authentication operations that do not require access to a remote authority such as the TSI server 120 in FIG. 3. The ledger is a data structure that is maintained by the host 134 and provides authenticating descriptive information regarding the collection 131. The ledger may take the form of a blockchain, or some other cryptographically protected data structure.

Each of the collection members 132 generates and stores certain cryptographic values used for authentication and, as required, data processing, and these values are incorporated into the ledger 140. A crypto block 142 represents cryptographic function capabilities of the host 134 that can be used to update and use the ledger 140. The ledger enables the host to establish a trust boundary (represented by broken line box 144) in which the collection members and the host reside, the trust boundary indicating the group is a trusted environment for the exchange of information among the various elements of the group, as well as with other trusted nodes within the network.

FIG. 5 shows a keystore 150 from each of the storage devices 132. The keystore is a secure memory location used to store various values including an internal token 152 and, as desired, an external token 154. Additional data may be stored as well, including portions of (or a complete copy of) the distributed ledger 140. The internal token 152 is associated with the corresponding storage device 132 and incorporates unique identifying (ID) information such as device serial number, parametric values, etc. The internal token 152 is cryptographically processed such as through the application of encryption, the generation of a hash value, etc. to protect the contents of the token. The external token 154 constitutes the internal token for a different one of the devices 132 in the collection 131. While not necessarily required, the storage of the various tokens by multiple combinations of the storage devices can serve to enhance system trust.

FIG. 6 shows a ledger block 160 in accordance with some embodiments. The ledger block 160 represents an accumulation of the authentication information associated with the collection members 132. It will be appreciated that the ledger block can take any number of suitable forms so that FIG. 6 is merely exemplary and is not limiting.

A first column 162 identifies the storage devices in the collection. In this example, there are a total of each (8) such members, identified as S0 through S7. Column 164 identifies the respective internal tokens for the collection members, identified as Token 0 through Token 7. These tokens may be the same as what are stored in the keystores 150 of the individual members, or may be in a cryptographically protected form (e.g., encrypted, etc.).

Column 166 shows the external token associations among the various members; for example, device S0 stores the external token for device S3, and so on. Column 168 shows registration information (Datecode 0 to Datecode 7) associated with each of the collection members. The registration information can take a variety of forms and may include date/time information relating to when each device was added to the collection, the authentication authority that was used to authorize the addition of the member to the collection, and so on. Column 168 shows security policy information (Policy 0 to Policy 7) relating to various restrictions or other policies set for the accessing of each collection member. Other formats and types of data may be included in the ledger block 160 as well, including configuration information, users, namespaces, etc.

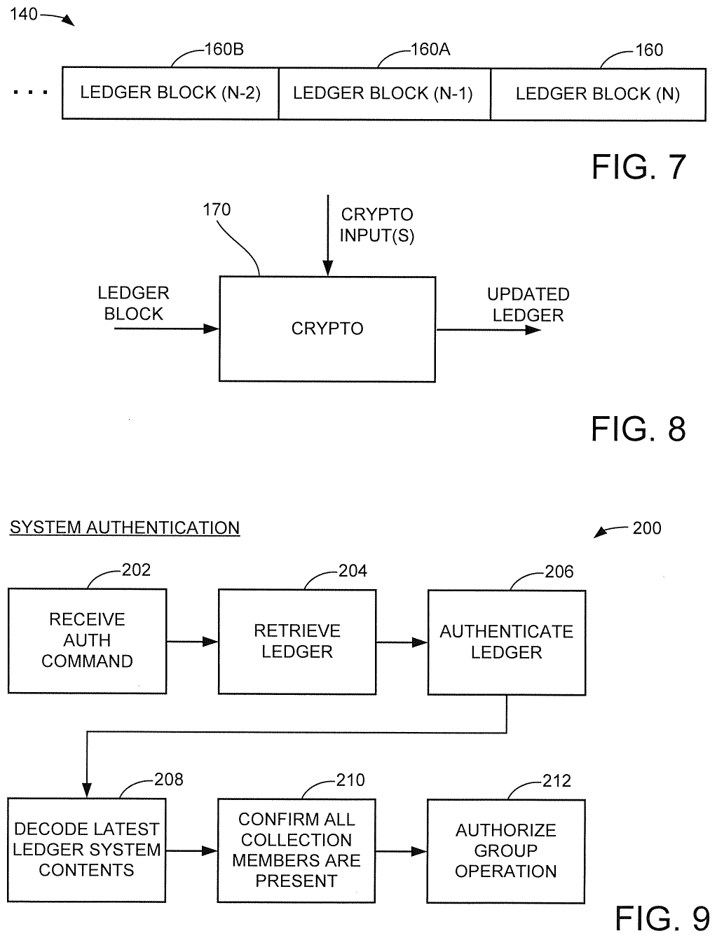

As with other types of ledger systems, the distributed ledger 140 is made up of a succession of ledger blocks such as the block 160. This can advantageously retain history data with respect to the configuration of the group 130 as well as enhancing data security, such as when the ledger is a blockchain formed by hashing together all of the preceding blocks. As shown in FIG. 7, the most current ledger block 160 from FIG. 6 is identified as ledger block N, and the ledger 140 further includes previous ledger blocks N−1 160A, ledger block N−2 160B, and so on.

FIG. 8 shows a processing operation carried out by the crypto block 142 in FIG. 4. Generally, a selected cryptographic (crypto) function 170 uses one or more crypto inputs to operate on the block 160 to generate the most recent (updated) version of the ledger 140. The crypto inputs can be encryption keys, seed values, counter values, nonce values, etc. In some cases, the crypto function 170 may be a hash function (e.g., SHA, etc.). In a blockchain application, the crypto function 170 may be a hash that combines all of the existing blocks in the ledger with a nonce value to generate the updated ledger. Once the updated ledger is generated, it is stored by the host 134 (FIG. 4) and, as required, in the various keystores 150 of the collection members 132 (FIG. 4).

FIG. 9 illustrates an authentication sequence 200 to demonstrate an exemplary manner in which the updated ledger 140 can be used to provide localized authentication of the system. This can be carried out at suitable times, such as upon system initialization when one or more of the various devices in the group 130 are transitioned from a deactivated state to an activated state. The authentication sequence 200 can be carried out at other suitable times as well. In one example, the authentication sequence is carried out automatically as a background process on a periodic basis, including at randomly selected intervals to ensure the system maintains the previously confirmed configuration. In another example, the authentication sequence is carried out in response to the detection of an anomalous event, such as a power loss event or the temporary disconnection of an interface cable or other interconnection among the various devices. In yet another example, the authentication sequence can be carried out responsive to a detection by a collection member of an unexpected acceleration event (such as from a multi-axial accelerometer), indicative of a potential physical removal of a device from the group. Failure to successfully complete the local authentication sequence 200 will result in a lockdown condition that prevents further access to the collection until the event is resolved.

The sequence 200 commences at block 202 with receipt of an authentication command. In response, the host 134 operates to retrieve a copy of the ledger 140, block 204. This retrieval can be carried out in a number of ways. In some cases, the copy that is resident in secured memory of the host 134 is accessed by the processor of the host. Additionally or alternatively, the distributed copies/portions are retrieved from the devices 132. An authentication block 206 authenticates the retrieved ledger. Any number of checksums, parity checks, ECC, cryptographic functions, etc. can be applied that the retrieved ledger 140 is valid and represents the most current version of the state of the system.

The processor of the host 134 proceeds at block 208 to analyze the decoded contents of the ledger block 160 to confirm the status of the various collection members 132. This can include requesting the respective tokens and other information from the respective keystores 150 of the drives, sending challenge values and receiving responses in a local TSI authentication process such as described in FIG. 3, etc. An aspect of this local authentication process is that the presence and verification information used to authenticate each of the members of the collection are resident in the ledger. Peer-to-peer authentication can take place at this time as well by the collection members sharing token information among themselves. This process will be explained in greater detail below.

Block 210 shows that once all collection members are confirmed as being present, normal group operation is authorized at block 212. Separate routines are carried out if an existing member is found to be missing, as well as if a new device is detected. Each of these conditions will now be discussed in turn.

It is contemplated in a mass-storage environment that all of the devices in the collection will be powered up and down concurrently, such as by being supplied with a common power supply circuit. In such case, a missing device may indicate that a device failure condition has occurred, or that a device may have been removed from the system (either by an authorized entity or not). In other environments, however, the various devices in the collection (such as an IoT application) the devices may be powered up independently, so that different members of the various devices may come online at different times. In this case, the authentication routine 200 of FIG. 9 may operate to locate all valid devices 132 that are currently responsive to inputs from the host 134. A system log report may be generated and incorporated into the ledger to indicate the then available devices in the collection.

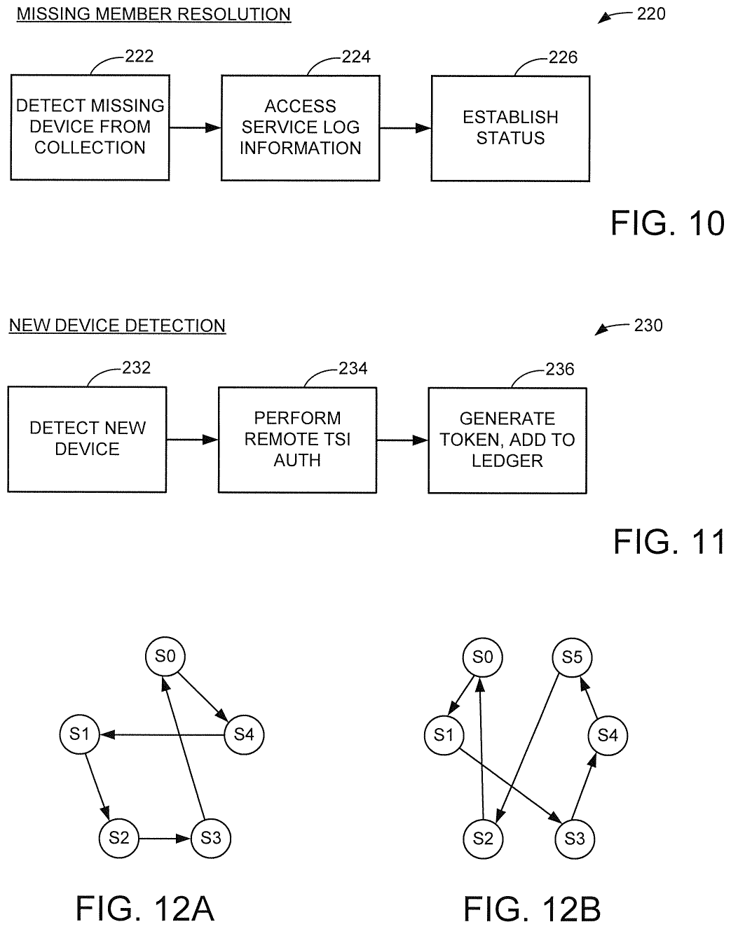

FIG. 10 provides a missing member resolution routine 220. These steps may be carried out in conjunction with the authentication routine 200 of FIG. 9 in the event that an expected device from the collection is found to be missing. Upon detection of the missing device, block 222, service log information is accessed at block 224 in an effort to determine whether a device failure has been reported. In some cases, a previous failure of a device may have resulted in the replacement of the device and the copying over/generation of the contents previously stored by the failed device to a new device. In other cases, the device may be fine but simply not online and active. Ultimately, the status of the device is established at block 226, with a determination made as to whether to continue to include the device in the collection during future authentication routines. This status is added to the ledger 140.

FIG. 11 shows a new device detection routine 230. The new device detection routine may also be carried out as part of the authentication routine 200 of FIG. 9, or may be carried out separately when a new device attempts to connect to the host 132. Generally, anytime that a new device is added to the group, an initial TSI routine is carried out such as described in FIG. 3 to authenticate the device. Once added to the group, processing is carried out as described above, including the generation of a new internal token for the new device as well as, as required, the distribution of an external token to the new device. In this way, remote access to the server can be used initially, but thereafter local authentication can be applied for subsequent operations.

FIGS. 12A and 12B show an initial group of five (5) devices 132 in a collection, identified as S0 through S4. The arrows indicate the storage of external tokens by the various devices; for example, S0 stores the token for S4, S4 stores the token for S1, and so on. As described above, the separate storage of tokens can be carried out as part of the ledger authentication process (FIG. 9). That is, as the host 134 proceeds to identify each storage device in turn as set forth by the decoded ledger, the host can not only request the internal token from each device, but also poll the devices to locate the second copy of the token from the other device. The tokens can be rearranged as required to ensure that every valid collection member stores its own valid token as well as a valid token from one other collection member.

As shown by FIG. 12B, a new device S5 is properly added to the collection pursuant to the routine 230 of FIG. 11. At this point, a new internal association of tokens may be made as shown.

A variety of token distribution strategies can be used when adding a new device to an existing collection. If the new device replaces a failed member that is no longer present in the group, the new device can simply store the external token that was held by the failed member, and the external token of the new device can be distributed to the other member that previously stored the external token for the failed member.

If the new device has been added to expand the size of the family, it may be more appropriate for the host device to form a new association pattern for all of the tokens among all of the collection members. It is further possible for the host device to form new association patterns periodically among the collection of devices as well. In one embodiment, after each successful authentication cycle, the host distributes new tokens among the various collection members so that a different association is used for the next authentication cycle that is performed.

As noted above, it is contemplated that the various collection members will be located in the same general geographical location, so that the host and member devices are sufficiently near one another to share a common geoposition such as in a multi-device storage enclosure, a rack, a data center, etc. It is possible, however, to geographically distribute the members of group, with communication between the host and the devices carried out using one or more networks to provide the local authentication described herein. Smaller sub-collections can perform the local authentication processing, after which multiple sub-collections may be treated as individual members in a larger network of nodes (extended collection) in a distributed system.

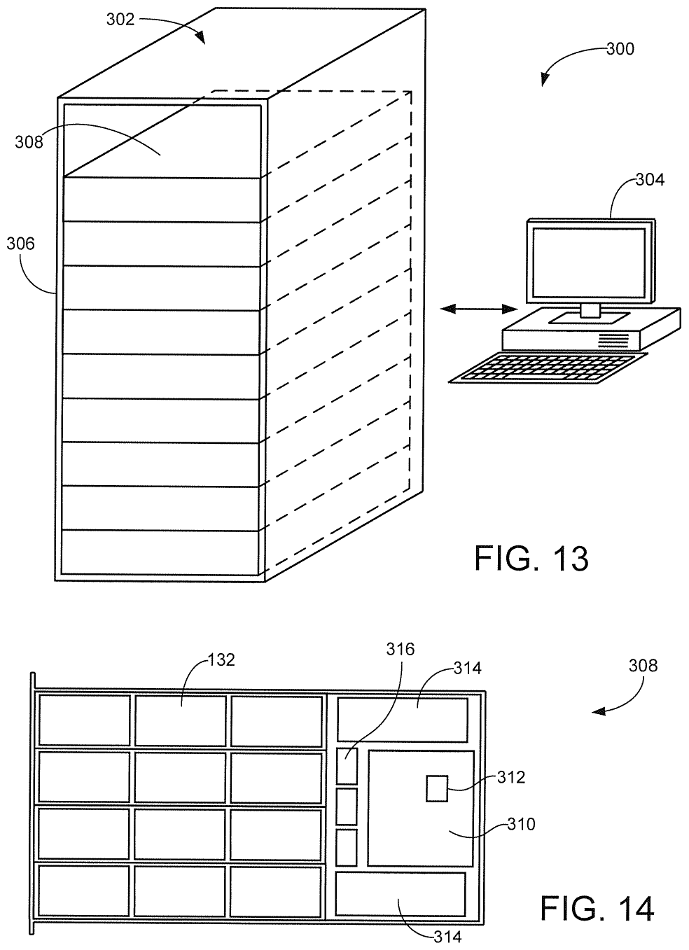

FIG. 13 provides a schematic depiction of a data storage system 300 in which various embodiments of the present disclosure may be advantageously practiced. The data storage system 300 is a mass-data storage system in which a large population of data storage devices such as 132 are incorporated into a larger data storage space to provide a storage node as part of a larger geographically distributed network. Examples include a cloud computing environment, a network attached storage (NAS) application, a RAID (redundant array of independent discs) storage server, etc.

The system 300 includes a storage assembly 302 and a computer 304 (e.g., server controller, etc.). The storage assembly 302 may include one or more server cabinets (racks) 306 with a plurality of modular storage enclosures 308. While not limiting, the storage rack 306 is a 42U server cabinet with 42 units (U) of storage, with each unit extending about 1.75 inches (in) of height. The width and length dimensions of the cabinet can vary but common values may be on the order of about 24 in.×36 in. Each storage enclosure 308 can have a height that is a multiple of the storage units, such as 2U (3.5 in.), 3U (5.25 in.), etc. to accommodate a desired number of adjacent storage devices 134. While shown as a separate module, the computer 304 can also be incorporated into the rack 306.

FIG. 14 is a top plan view of a selected storage enclosure 308 that incorporates 36 (3×4×3) data storage devices 132. Other numbers and arrangements of data storage devices can be incorporated into each enclosure, including different types of devices (e.g., HDDs, SDDs, etc.). The storage enclosure 308 includes a number of active elements to support the operation of the various storage devices, such as a controller circuit board 310 with one or more processors 312, power supplies 314 and cooling fans 316.

The modular nature of the various storage enclosures 308 permits removal and installation of each storage enclosure into the storage rack 306 including under conditions where the storage devices 132 in the remaining storage enclosures within the rack are maintained in an operational condition. In some cases, the storage enclosures 308 may be configured with access panels or other features along the outwardly facing surfaces to permit individual storage devices, or groups of devices, to be removed and replaced. Sliding trays, removable carriers and other mechanisms can be utilized to allow authorized agents to access the interior of the storage enclosures as required.

All of the storage devices 134 in the storage enclosure 308 can be incorporated into a collection. In the example of FIG. 15, this would provide a trust family with 36 storage devices. The trust family host functions can be executed by the processors 312 on the storage enclosure control board 310. Each time the storage enclosure 308 is activated, and at other suitable times, the authentication processing of FIG. 9 can be carried out to quickly validate the integrity of the enclosure devices.

In further embodiments, sets of devices 132 within the storage enclosure 308 can be established as separate collections, so that each storage enclosure incorporates two or more collections within the same enclosure. In one example, N devices 132 in the storage enclosure 308 in FIG. 14 can form a first collection, and the remaining 36-N devices can form a second collection. Performing authentication processing of these two collections in parallel would tend to reduce authentication time. In still other arrangements, collections can be arranged to span multiple storage enclosures, including all of the enclosures in the rack 302.

It will now be appreciated that the various embodiments discussed herein can provide a number of benefits. Localized authentication as exemplified herein can provide fast and efficient validation of collection members with a high level of trust. While various embodiments have contemplated an illustrative environment that uses a group of storage devices such as SSDs, it will be appreciated that the various examples are not so limited and that the various processing herein can be applied to any number of different groups and types of processing devices, such as computing devices, communication devices, sensing devices, etc. that utilize security measures to provide and govern security access.

It is to be understood that even though numerous characteristics and advantages of various embodiments of the present disclosure have been set forth in the foregoing description, this description is illustrative only, and changes may be made in detail, especially in matters of structure and arrangements of parts within the principles of the present disclosure to the full extent indicated by the broad general meaning of the terms wherein the appended claims are expressed.

What is claimed is:

1. An apparatus comprising:
a plurality of processing devices arranged as collection, each processing device storing an internal token value comprising a unique ID value associated with the corresponding processing device; and
a host controller circuit configured to perform a local authentication of the collection by accessing a distributed ledger as a data structure in a memory that lists the internal token values of the respective processing devices.

2. The apparatus of claim 1, wherein the distributed ledger is arranged as a blockchain.

3. The apparatus of claim 1, wherein each processing device further stores a copy of the distributed ledger and transfers the copy of the distributed ledger to the host controller circuit during the local authentication.

4. The apparatus of claim 1, wherein each processing device further stores an external token value comprising the internal token value of one other processing device in the collection.

5. The apparatus of claim 4, wherein the host controller circuit further performs the local authentication by retrieving the external token values stored by the respective processing devices in the collection.

6. The apparatus of claim 1, wherein the host controller circuit performs the local authentication by retrieving the distributed ledger, authenticating the distributed ledger and locating each of the processing devices via the internal tokens as listed in a most recent block of the distributed ledger.

7. The apparatus of claim 1, wherein the host controller circuit is further configured to add a new processing device to the collection responsive to detecting the new processing device during the local authentication, the host controller circuit authenticating the new processing device via communications, over a network, with a remote authorized server, the host controller further operating to add an internal token value associated with the new processing device to the distributed ledger.

8. The apparatus of claim 1, wherein the host controller circuit authenticates the collection by forwarding a first query to each of the processing devices, and evaluating a corresponding response from each of the processing devices generated using the internal token value stored by the associated processing device.

9. The apparatus of claim 1, wherein the distributed ledger comprises a sequence of ledger blocks, each ledger block updated responsive to a separate authentication operation to authenticate the collection, each ledger block listing the processing devices in the collection, the associated internal tokens for the processing devices, registration information associated with the processing devices, and security policy information associated with the processing devices.

10. The apparatus of claim 1, wherein the processing devices comprise data storage devices each having a data storage device controller circuit and a non-volatile memory (NVM) to store user data supplied by the host device.

11. The apparatus of claim 1, wherein the host controller circuit comprises a crypto circuit that applies a cryptographic function to cryptographically protect the distributed ledger and a local secure memory in which a copy of the cryptographically protected distributed ledger is stored.

12. The apparatus of claim 1, wherein the host controller circuit is an edge computing device in a cloud networking environment.

13. A method comprising:
forming a collection of processing devices each storing a unique internal token value in a keystore memory;
generating, by a host controller circuit coupled to the processing devices, a distributed ledger as a data structure in a memory, the distributed ledger including a copy of the internal token values stored by the processing devices; and
using the host controller circuit to perform a local authentication of the collection of the processing devices by decoding the distributed ledger and confirming the internal token values from the distributed ledger match the internal token values stored by the processing devices.

14. The method of claim 13, further comprising detecting a new device during the local authentication, authenticating the new device by communicating, via a network, security information between the host controller circuit and a remote trusted authority server, generating a new internal token value for the new device, and adding the new internal token value for the new device to the distributed ledger.

15. The method of claim 13, wherein the distributed ledger is a blockchain.

16. The method of claim 13, wherein each of the processing devices further stores an external token value comprising the internal token value of a selected one of the other processing devices in the collection, wherein the distributed ledger identifies which processing device stores which external token value in the collection, and wherein the host controller circuit further uses the external token values to authenticate the collection.

17. The method of claim 13, wherein the host controller circuit authenticates the collection by forwarding a first query to each of the processing devices, and evaluating a corresponding response from each of the processing devices generated using the internal token value stored by the associated processing device.

18. The method of claim 13, wherein the distributed ledger comprises a sequence of ledger blocks, each ledger block updated responsive to a separate authentication operation to authenticate the collection, each ledger block listing the processing devices in the collection, the associated internal tokens for the processing devices, registration information associated with the processing devices, and security policy information associated with the processing devices.

19. A method comprising:
adding a new storage device to an existing collection of storage devices coupled to an edge computing device in a cloud computing network;
authenticating, through communications between the edge computing device and a trusted server across the network, the new storage device, the authenticating including a transfer of security information to the new storage device for storage in a secure memory thereof;
appending the security information to a distributed ledger maintained by the edge computing device, the distributed ledger listing security information for each of the existing collection of storage devices; and
establishing a trust boundary that includes the new storage device, the existing collection of storage devices and the edge computing device responsive to a local authentication operation using the distributed ledger without reference to the trusted server.

20. The method of claim 19, wherein each of the new storage device and the existing collection of storage devices comprise a solid-state drive (SSD) with a storage device controller circuit and a flash memory.
